(19) United States
(12) Patent Application Publication
(10) Pub. No.: US 2012/0086323 A1
(43) Pub. Date: Apr. 12, 2012

(54) DISPLAY AND METHOD AND APPARATUS FOR MANUFACTURING A DISPLAY

(75) Inventors: Michel Josephus Marie Somers, Eindhoven (NL); Fredericus Johannes Touwslager, Eindhoven (NL); Nicolaas Aldegonda Jan Maria van Aerle, Eindhoven (NL)

(73) Assignee: Polymer Vision B.V., Eindhoven (NL)

(21) Appl. No.: 13/269,291

(22) Filed: Oct. 7, 2011

(30) Foreign Application Priority Data
Oct. 11, 2010 (NL) NL 2005498

(51) Int. Cl. H01J 5/16; H01J 9/42; H01J 9/20

(52) U.S. Cl. 313/112; 445/24; 445/3; 445/66; 445/63

(57) ABSTRACT

A method is described for manufacturing a display. The method includes providing a display layer for displaying an image having at least a luminosity component, providing a color filter layer comprising a color filter for filtering the image according to a predetermined pattern, and removably attaching the color filter layer to the display layer. Dependent on the outcome of a test on the product provided with the removably attached color filter layer it may be decided to remove the color filter layer.

### CROSS-REFERENCE TO RELATED APPLICATION

This application claims the priority benefit of Somers et al., Netherlands Patent Application Serial No. NL 2005498, filed on Oct. 11, 2010, entitled “Display As Well As Method And Apparatus For Manufacturing A Display,” the contents of which are incorporated herein by reference in its entirety, including any references therein.

### BACKGROUND

1. Field of the Invention

The present invention relates to a display. The present invention further relates to a method for manufacturing a display. The present invention further relates to an apparatus for manufacturing a display.

2. Background of the Invention

Multicolor displays are known that have a display effect layer capable of generating a pattern by reflecting, transmitting or emitting light with a broad color spectrum (white) and a color filter layer that is capable of converting said light into colored light. One such display is known from WO2007/063440.

FIG. 1 schematically shows a typical conventional display for displaying a color image. The display comprises a substrate 2, a display layer 4 and a color filter layer 6. The display layer is typically composed of a stack of sub-layers, including a bottom electrode layer 42, a display effect layer 44 and a top electrode layer 46. The bottom electrode layer 42 may comprise a plurality of electrode elements (not shown) that may be controlled by corresponding control elements in an active matrix layer. The top electrode layer 46 typically is a continuous, transparent electrode. The display effect layer 44 comprises display elements 440 having an optical property that is controlled by the electrodes 42, 46. In this embodiment the display elements 440 are electrophoretic elements formed by capsules with a dispersion of electrically charged black and white or colored nano-particles in a clear solution. Each picture element (pixel), i.e. independently controlled unit of the display, may comprise one or more of the display elements 440. The display elements 440 need not necessarily be aligned with the pixel boundaries. The display layer 4 is constructed to display an image having at least a luminosity component, and the color filter layer 6 comprises a color filter with a plurality of color filter elements 64 (red), 66 (green), 68 (blue) for filtering the image according to a predetermined pattern. The color filter layer 6 further comprises transparent colorless elements 62.

The color filter layer 6 may be implemented in various ways. In the example of FIG. 2A, each pixel has 4 sub-pixels that are arranged in 4 quadrants of a rectangle. Therein sub-pixel 2a includes a display element that corresponds to a color-less filter element, and sub-pixels 2b, 2c and 2d respectively include a display element that respectively corresponds to a red, green and blue color filter element. In the example of FIG. 2B, each pixel comprises three elongate sub-pixels 1a, 1b, 1c that are arranged lengthwise along each other. FIG. 2C shows a third example wherein three square subpixels 3a, 3b, 3c of each primary color are arranged within a T-shaped pixel.

The application of the color filter 6 requires additional manufacturing steps. If these steps are not successful the quality of the product may be low, or the product may even be unsuitable for use. Various causes may result in a failure of the additional manufacturing steps, such as the presence of particles, malfunctioning of the equipment, and/or human errors. There is a need to at least mitigate these disadvantages caused by failure introduced during the additional manufacturing steps.

### SUMMARY OF THE INVENTION

According to a first aspect of the present invention a display is provided. According to a second aspect of the present invention a method is provided. According to a third aspect of the present invention an apparatus is provided.

The display according to the first aspect of the invention has a removably attached color filter. Accordingly, if it is determined that the display does not comply with the requirements due to a failure introduced during the additional manufacturing steps, it is possible to remove the color filter layer. From the color filter layer removal, a compliant monochrome or black and white display is obtained. Alternatively, a new attempt may be made to apply a color filter layer to the display layer.

The method according to the second aspect of the invention is characterized by removably attaching the color filter layer to the display layer. Accordingly, if after carrying out the additional manufacturing steps it is recognized that the manufactured product does not comply with the requirements for a color display, it is possible to remove the color filter and use the product as a monochrome or a black and white display.

The apparatus according to the third aspect of the invention is characterized by a third unit for removably attaching the color filter layer to the display layer.

Accordingly, if after carrying out the additional manufacturing steps it is recognized that the manufactured product does not comply with the requirements for a color display, it is possible to remove the color filter and use the product as a monochrome or a black and white display.

The wording “removably attached” is understood to mean that the color filter layer can be removed from the display layer without damaging the display layer. Nevertheless the color filter layer should be sufficiently tightly attached to the display layer to prevent a spontaneous release thereof during normal use of the device.

As used herein, a “layer” of a given material includes a region of that material whose thickness is small compared to both its length and width. Examples of layers include sheets, foils, films, laminations, coatings, and so forth. As used herein a layer need not be planar, but can be bent, folded or otherwise contoured, for example, to at least partially envelop another component. As used herein a layer can also include multiple sub-layers. A layer can also consist of a collection of discrete portions such as, for example, a layer of discrete active regions comprising individual pixels.

Accordingly, an embodiment of the method according to the second aspect further comprises a step of testing the display after the step of removably attaching the color filter layer and a step of removing the color filter layer from the display layer if the display does not positively pass this test. The resulting display layer may be used in a monochromatic display, or a new attempt may be made to provide the display layer with a color filter layer. Hence in the method according to the second aspect of the invention, the materials and efforts spent in the previous manufacturing steps are not lost if the test indicates that the color filter layer is not correctly attached to the display layer.

Likewise an apparatus according to the third aspect of the invention comprises:
a fourth unit for testing a quality of the product obtained by removably attaching the color filter layer to the display layer, and for providing a failure signal if the quality of the product is not acceptable, and
a fifth unit for removing the color filter layer from the display layer upon activation of the failure signal.

Alternatively, the fourth and the fifth unit may be provided as a separate apparatus.

Various options are possible to removably apply the color filter layer and to remove the color filter layer in case it is detected that the additional manufacturing steps did not result in an acceptable color display.

According to a first option the color filter layer is removably attached to the display layer by an intermediate adhesion layer having a relatively low adherence to the display layer as compared to the adhesion to the color filter layer. The step of removing the color filter layer from the display layer, if the display does not positively pass this test, is carried out by peeling of the color filter layer from the display layer. Release of the color filter layer with the adhesion layer may be promoted by a temperature increase.

According to a second option the color filter layer comprises a release layer at a surface attached to the display layer. The step of removing the color filter layer from the display layer, if the display does not positively pass this test, is carried out by peeling of the color filter layer from the display layer.

According to a third option the color filter layer is attached to the display layer by means of an intermediate layer that is soluble in a solvent that does not solve the display layer. The step of removing the color filter layer from the display layer, if the display does not positively pass this test, is carried out by selectively solving the intermediate layer in a solvent.

According to a fourth option the color filter layer is soluble in a solvent that does not solve the display layer. The step of removing the color filter layer from the display layer, if the display does not positively pass this test, is carried out by selectively dissolving the color filter layer in a solvent. This is advantageous in that an intermediate layer is superfluous.

An embodiment of the method according to the second aspect of the invention further comprises the step of testing the provided display layer, and the step of removably attaching the color filter layer is only carried out after the provided display layer has positively passed the step of testing. In this way the step of removably attaching the color filter is avoided if it is known beforehand that the manufacturing process will not result in an acceptable display anyhow.

If the method according to the second aspect of the invention is successfully completed, a display according to the first aspect of the invention is obtained that comprises a display layer for displaying an image having at least a luminosity component and a color filter layer releasable attached thereto that comprises a color filter for filtering the image according to a predetermined pattern.

### BRIEF DESCRIPTION OF THE DRAWINGS

These and other aspects of a display and method for making a display are described in more detail with reference to the drawings wherein:

FIG. 1 shows a prior art display unit having a display layer and a color filter layer,

FIG. 2 shows known arrangements of a color filter layer,

FIG. 3 shows a first embodiment of a display unit according to the first aspect of the present invention,

FIG. 4 shows an embodiment of a method according to the second aspect of the invention,

FIGS. 4A to 4D further illustrates various steps in the embodiment of the method of FIG. 4, and more particularly therein

FIG. 4A further illustrates a first step S1 of the method,

FIG. 4B further illustrates a second step S2 of the method,

FIG. 4C further illustrates a first sub-step S5A of a fifth step S5 of the method,

FIG. 4D further illustrates a second sub-step S5B of the fifth step S5 of the method,

FIG. 5A shows an embodiment of an apparatus according to the third aspect of the invention in a first operational state,

FIG. 5B shows the embodiment of the apparatus according to the third aspect of the invention in a second operational state,

FIG. 6A schematically shows an alternative embodiment of the apparatus according to the third aspect of the invention,

FIG. 6B shows a part of the apparatus of FIG. 6A in more detail,

FIG. 6C schematically shows another alternative embodiment of the apparatus according to the third aspect of the invention,

FIG. 7 illustrates a first sub-step S5A carried out by said part in more detail, and

FIG. 8 illustrates a second sub-step S5B carried out by said part in more detail.

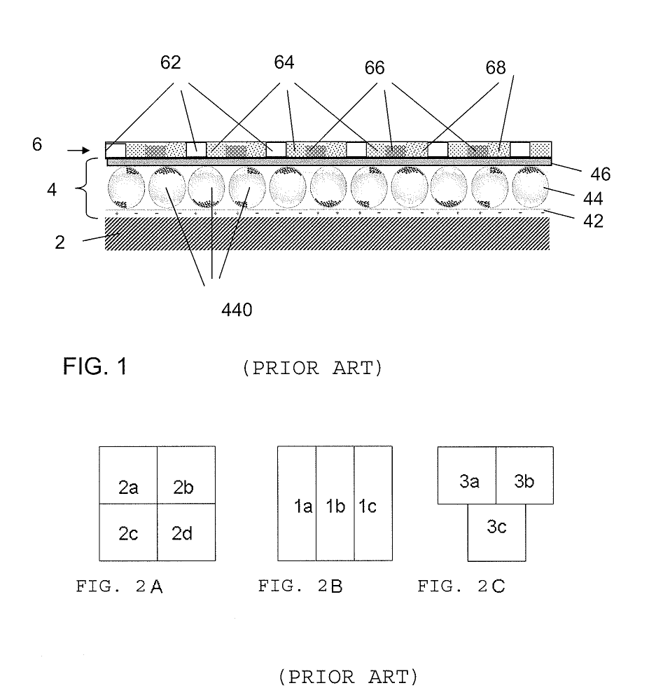

### DETAILED DESCRIPTION OF EMBODIMENTS

In the following detailed description numerous specific details are set forth in order to provide a thorough understanding of the present invention. However, it will be understood by one skilled in the art that the present invention may be practiced without these specific details. In other instances, well known methods, procedures, and components have not been described in detail so as not to obscure aspects of the present invention.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes and sizes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element or layer is referred to as being “coupled to” another element or layer, it can be directly on, connected or coupled to the other element or layer or intervening elements or layers may be present. In contrast, when an element is referred to as being “connected to” another element or layer, there are no intervening elements or layers present. Like numbers refer to like elements throughout. As used herein, the term “and/or” includes any and all combinations of one or more of the associated listed items.

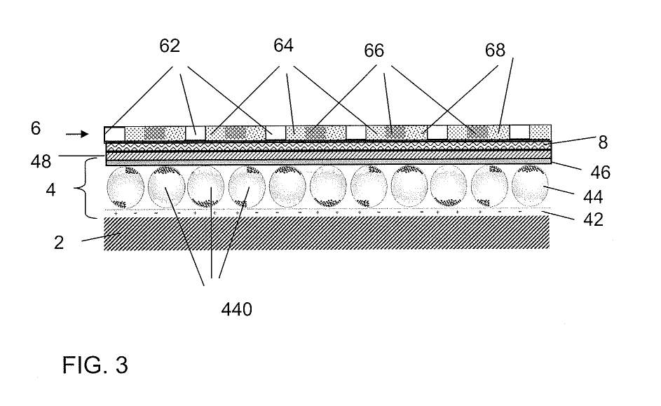

FIG. 3 shows a first embodiment of a display according to the first aspect of illustrative examples of the present invention. The display therein comprises a substrate 2. In the embodiment shown, the substrate is a polymer foil, such as a PET (Poly Ethylene Terephthalate) or PEN (Poly Ethylene Naphthalate) layer having a thickness of less than 50 μm, preferably about 25 μm. Alternatively, a metal foil may be used as the substrate. It is not necessary that the substrate is flexible. In an alternative embodiment a rigid substrate, e.g. a glass plate, may be used. The substrate 2 carries a display layer 4 that comprises a display effect layer 44 arranged between a backplane 42 with an active matrix layer and electrode elements and a transparent electrode layer 46. The display effect layer 44 comprises a plurality of display elements 440, depicted here in the form of electrophoretic elements. Alternatively, other display elements, e.g. liquid crystal elements, or (O)LEDs, may be used as the display elements. The display further comprises a color filter layer 6 that is removably attached to the display layer 4. The structure of the color filter layer 6 can be matched to the type of display elements used. For example, for use in combination with electrophoretic elements as the display elements, the color filter may comprise colorless transparent spacings 62. Whereas, for use in combination with liquid crystal display elements, the color filter elements 64 (red), 66 (green), 68 (blue) may even overlap for example. The removable attachment of the color filter layer 6 to the display effect layer 4 makes it possible to remove the color filter layer 6 from the display effect layer 4 if it is determined that the color filter layer 6 was not properly attached to the display effect layer 4. In the embodiment shown, the color filter layer 6 is removably attached to the display layer by an intermediate weak adhesion layer 8. In practice an intermediate substrate 48 may be present between the adhesion layer 8 and the common electrode 46. The material used for the intermediate substrate is typically a polymer, e.g. PET or PEN. The intermediate substrate may have a thickness on the order of a few micrometers to a few tens of micrometers, e.g. 12.5 micrometer.

The term “weak adhesion” is understood to mean that the peeling force for releasing the layer 8 from at least one of the color filter layer 6 and the display effect layer 4 is preferably at most 3.2 g/mm at room temperature (20° C.). Nevertheless, the peeling is preferably at least 0.8 g/mm so that a spontaneous separation of the color filter layer 6 from the display effect layer 4 is prevented. Nevertheless, an adhesion layer may be used having a temperature dependent adhesion. For example an adhesion layer may be used having an adhesion decreasing with temperature. In that case the peeling strength at room temperature may be higher than 3.2 g/mm, e.g. 10 g/mm.

In an embodiment the adhesion layer 8 has a relatively low adherence to the display layer 4 as compared to the adhesion to the color filter layer 6. In that case the color filter layer 6 can be removed together with the adhesive layer 8 from the display layer 4. In the illustrative embodiment the adhesive is an EVA adhesive (ethylene vinyl acetate). Other suitable adhesives are (urethane) acrylics.

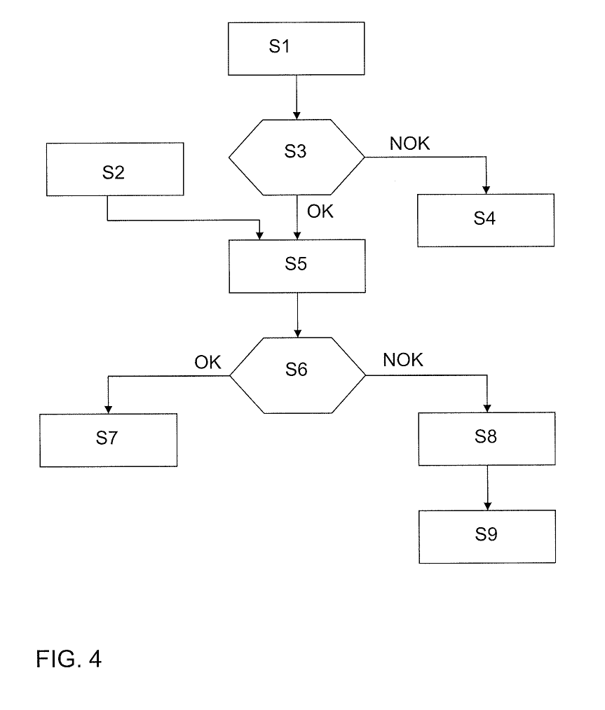

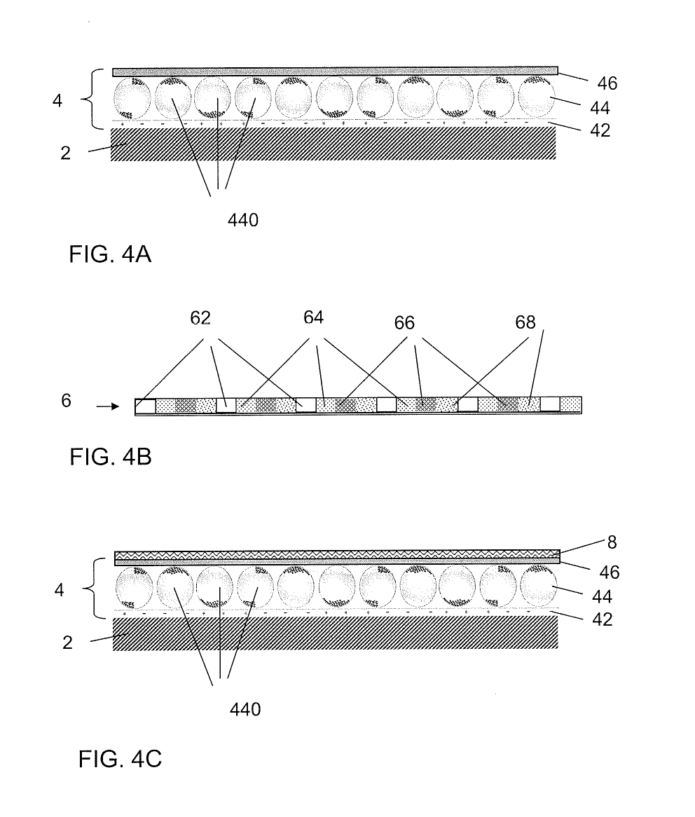

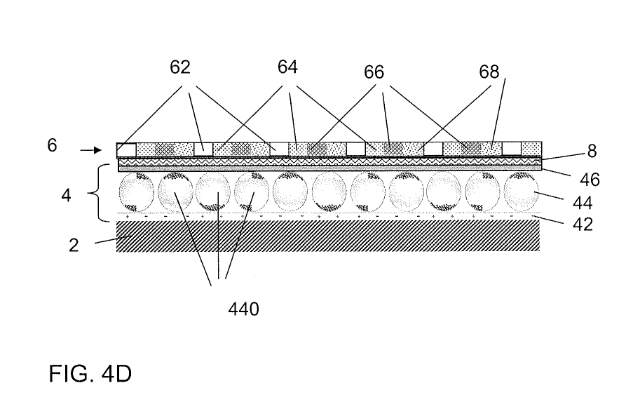

FIG. 4 schematically shows a method for manufacturing a display according to the second aspect of the present invention. The method comprises a first step S1 of providing a display layer as shown in FIG. 4A for displaying an image having at least a luminosity component. Various ways are known to manufacture a display layer and for clarity these will not be described in detail here.

In a second step S2 a color filter layer comprising a color filter for filtering the image according to a predetermined pattern is provided, as is shown in FIG. 4B. Also the color filter layer is manufactured in a way known as such to the skilled person. In a practical embodiment the color filter layer is directly processed upon the display layer. Said processing may involve for example a step of spinning and lithographic treatment for each of the color filter layers. Alternatively the color filter layer may be manufactured separately and be subsequently laminated upon the display layer.

In a third step S3 the display layer is tested. During this test it is determined whether the display layer correctly functions. If it is determined that the display layer does not comply with the requirements (NOK) the display layer is rejected in step S4 before attaching the color filter layer, so that the latter can be used for another product.

If it is determined that the display layer does comply with the requirements (OK) then in step S5 the color filter layer is attached removably to the display layer.

As shown in FIG. 4C, step S5 comprises a first sub-step S5A of applying an adhesive to a surface of the display layer at a side that is to be provided with the color filter layer. The adhesive may be applied for example by a printing process. The adhesive, e.g. EVA may be heated to reduce the viscosity, therewith facilitating the printing process. In an embodiment of the method the display layer may already be prepared with a removably attached intermediate substrate. This embodiment can be implemented very cost-effectively in a roll to roll method.

In a second sub-step S5B, as shown in FIG. 4D, the color filter layer is laminated to the surface of the display layer 4 provided with the adhesive layer 8. Therewith the product of FIG. 3 is obtained.

In a subsequent step S6, the product so obtained is tested. The test may comprise application of test signals to the display manufactured in steps S1, S2, S3 and S5 and to determine whether the generated color image corresponds to a reference image.

If it is determined in step S6 that the product passes the test (OK), the manufacturing processes for the product, e.g. integration with other components, may be continued if necessary, and the product may be packaged. Alternatively, the so obtained display may be sold as a semi-finished product.

If it is determined in step S6 that the product does not pass the test (NOK), then the color filter layer is removed from the display layer during step S8.

Upon completion of step S8, the malfunctioning color display becomes a well functioning black and white or monochrome display. The so obtained black and white or monochrome display may be further processed during step S9, e.g. by integration of the display with other components and packaging. Alternatively, the so obtained display may be sold as a semi-finished product.

According to yet another alternative step S5 may be repeated, involving application of a new removable intermediate substrate at the display layer and application of a new color filter at the new intermediate substrate.

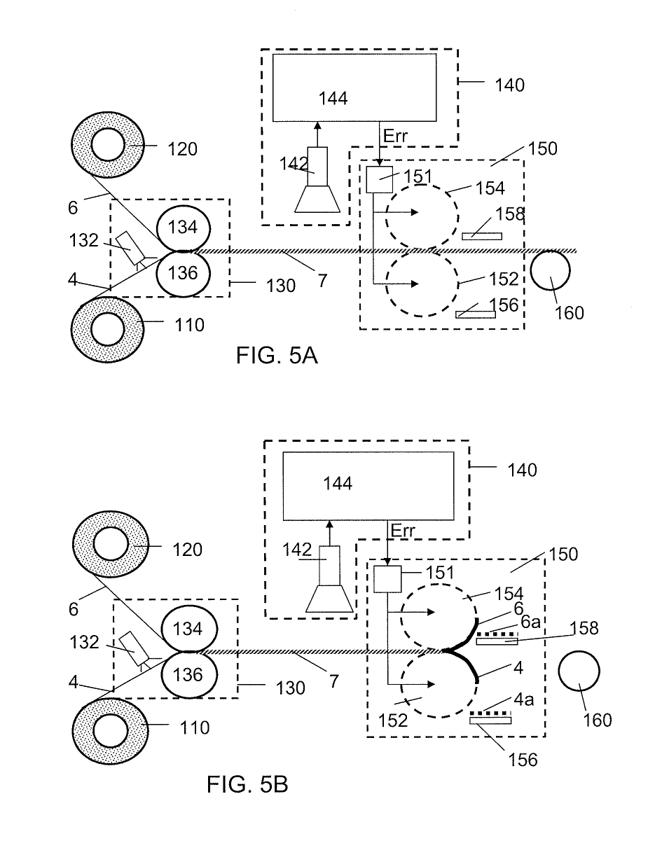

FIG. 5A, 5B illustrate an apparatus for manufacturing a product according to the third aspect of illustrative examples of the present invention. The apparatus comprises a first unit 110 for providing a display layer 4. The display layer is arranged for displaying an image having at least a luminosity component. In the embodiment shown the first unit 110 is a supply roll that supplies the display layer 4 laminated on a substrate as shown in FIG. 4A.

The apparatus comprises a second unit 120 for providing a color filter layer for filtering the image according to a predetermined pattern

The apparatus comprises a lamination unit 130 for removably attaching the color filter layer 6 to the display layer 4. The lamination unit 130 comprises an applicator 132, for example a printer, for applying an adhesive layer at a surface of the display layer 4 to be provided with the color filter layer and further comprises a pair of lamination rolls 134, 136. In FIG. 5A, 5B reference numeral 7 denotes the laminated product comprising the display layer 4 and the color filter layer 6.

The apparatus comprises a third unit 140 for testing a quality of the product having the removably attached color filter layer on the display layer. In this embodiment the third unit comprises a camera 142 and a controller 144. The camera 142 provides an image of the product to the controller 144. The controller 144 verifies whether the display layer 4 and the color filter layer 6 are properly aligned, for example by determining a relative position of alignment marks present in the display layer and the color filter layer. In a further test a yield is determined. For example it may be determined whether color elements in the color filter layer are missing or incomplete. If the display layer 4 and the color filter layer 6 are not properly aligned, or the product would otherwise have an unacceptable low quality, a failure signal Err is provided.

The apparatus comprises a fourth unit 150 for removing the color filter layer 6 from the display layer 4 upon activation of the failure signal Err.

The fourth unit 150 comprises a first and a second roll 152, 154 having a perforated outer surface. In the absence of the failure signal Err the first and the second roll 152, 154 guide the laminated product 7 towards further guidance means, here indicated by a guidance roll 160.

In the case the failure signal Err is activated, a vacuum pump 151 is switched on that evacuates the interior of the first and a second roll 152, 154. The pressure difference between the environment and the surface of the rolls causes the display layer 4 and the color filter layer 6 to be torn apart. The display layer 4 is carried away by the first roll 152 and the color filter layer 6 is carried away by the second roll 154. After a sufficient part of the display layer 4 and the color filter layer 6 are separated from each other, these parts may be separated from their respective remainders by, for example, cutting (e.g. by laser cutting). After separation, the pressure inside the rolls 154, 156 may be restored so that the disconnected parts 4a, 6a drop onto respective transport facilities 156 and 158, as indicated by dotted lines.

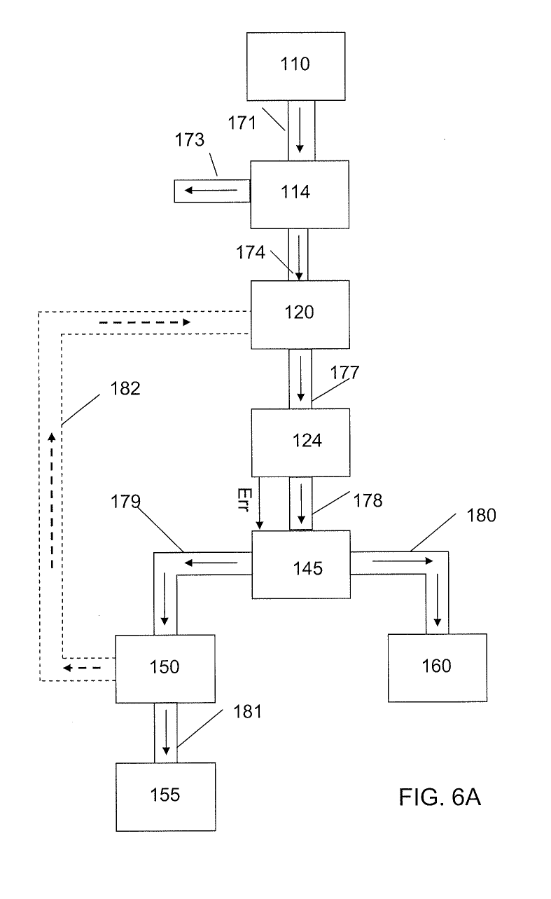

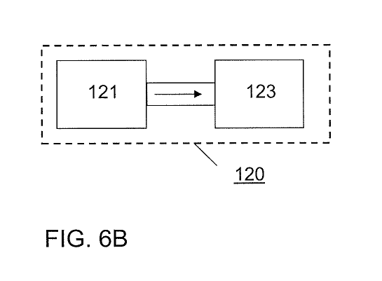

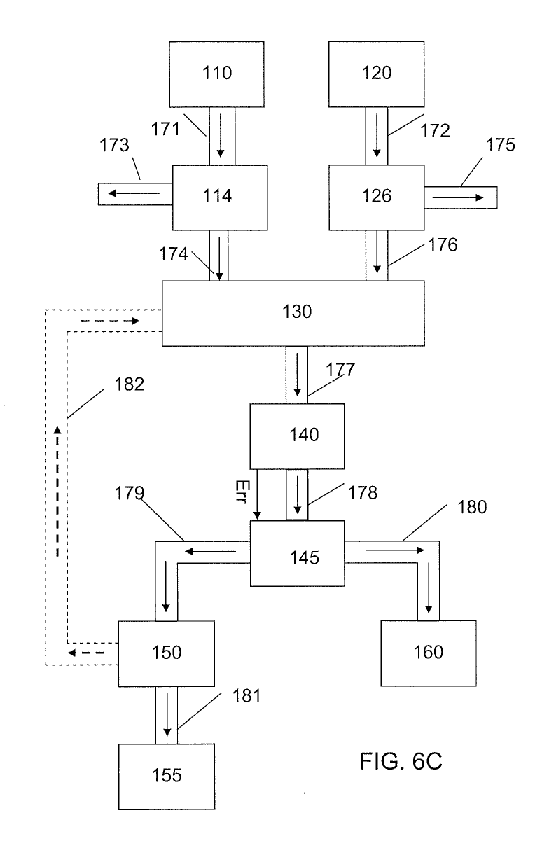

FIGS. 6A and 6B schematically show a first and a second alternative embodiment of an apparatus for manufacturing a display. The apparatuses of FIGS. 6A, 6B differs from the apparatus of FIGS. 5A, 5B in that the product is manufactured piecewise contrary to the apparatus of FIGS. 5A, 5B that manufactures the products in a roll to roll process.

The apparatus of FIG. 6A comprises a first unit 110 for providing a display layer. The said display layer is arranged for displaying an image having at least a luminosity component. In practice the manufacturing of a display layer requires a plurality of modules for executing a plurality of manufacturing steps. It is however well known to the skilled person how to implement these steps and the required equipment, so that these aspects are not described in detail here in order not to obscure the description of the present invention. The apparatus of FIG. 6A further has a second unit 120 for providing a color filter layer for filtering the image according to a predetermined pattern. Likewise the second unit 120 is not shown in detail. The display layer 4 provided by the first unit 110 is transported by a transport facility 171 to a first test station 114. In this test station 114 line and pixel faults are determined. In the test station 114 a display layer that does not comply with the requirements is carried away by transport away 173. Compliant display layers are transported by transport facility 174 to a second unit 120, wherein a color filter layer 6 is applied to the display layer 4. Although for clarity the second unit 120 is shown as a single block, this unit will in practice comprise a plurality of modules. In a first module for example an intermediate substrate is attached at a surface of the display layer 4 remote from the substrate 2. In a second module of the second unit a color filter layer is applied. In an embodiment of the second module color filter elements for respective primary colors are applied at the intermediate substrate. For each of the primary colors, this involves for example a spin coating step, followed by a lithographic step.

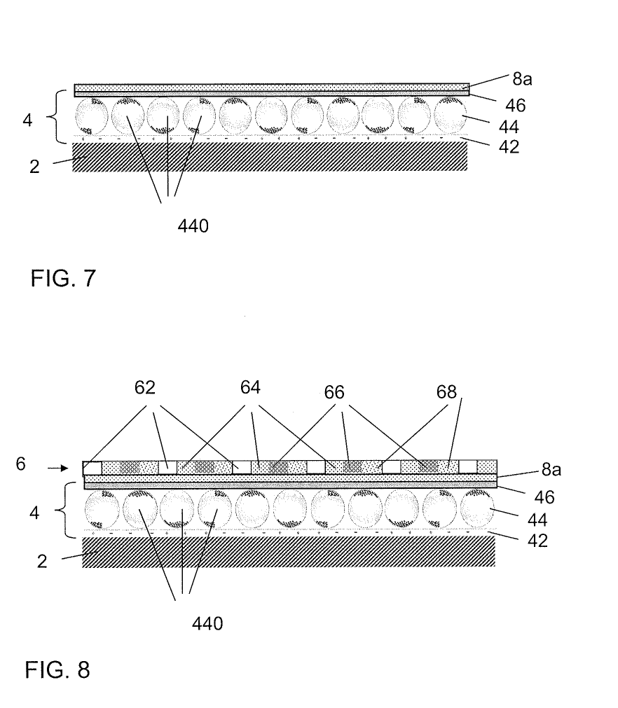

FIG. 6B shows the second unit 120 in more detail. As shown therein, the second unit 120 comprises a first module 121 wherein a color filter resist layer 8a is applied at a side of the display layer 4 that is to be provided with the color filter layer. In an embodiment the color resist layer is applied by spinning a color resist material at said side of the display layer 4. Nevertheless the color resist material may also be applied by other methods, e.g. by printing. The color filter resist layer 8a may, for example, be any of a set of commercially available photo-resist materials, preferably having a low process temperature (e.g., not higher than about 80 to 90° C.). Suitable materials for this purpose are, for example, the “color mosaic” series, available from Fujifilm. The semi-finished product so obtained, as shown in FIG. 7, is then transported to a second module 123 wherein the color resist layer 8a is cured, for example, by application of UV-radiation. Modules 121 and 123 carry out step S5A of an embodiment of the method described with reference to FIG. 4, resulting in the semi-finished product of FIG. 8.

The semi-finished product having the color filter layer 6 removably attached to the display layer 4 is then transported by transport facility 177 to test facility 124.

Test facility 124 verifies whether the semi-finished product complies with predetermined test requirements, e.g., whether the color filter layer 6 is properly aligned with the display layer, and/or whether the color filter layer is complete, i.e., whether no color filter elements are missing. In the test facility it may also be verified whether the product is free from dust particles encapsulated between the display layer and the color filter layer. This corresponds to step S6 of the method. The test facility 124 generates a signal Err having a value dependent on the outcome of the test generates a test signal Err. The tested semi-finished product is transported by transport facility 178 to a distribution unit 145. If the test signal Err indicates that the semi-finished product does not comply with the requirements the distribution facility transports the semi-finished product by transport facility 179 to the fourth unit 150 for removing the color filter layer 6 from the display layer 4. The fourth unit 150 comprises a facility that removes the intermediate substrate carrying the color filter from the display layer. Therewith the color filter layer 6 is released from the display layer 4. This corresponds to step S8 of the method. Then the display layer 4 from which the color filter layer 6 is removed is then further transported by transport facility 181 for further handling as a monochrome or a black and white display unit, corresponding to step S9. For example it may be packaged by a packaging unit 155. It is alternatively possible that the display layer 4 of which the color filter layer 6 was released is fed back to the second unit 120 by a transport facility 182 to attempt to apply a new color filter layer. In case the test signal Err indicates that the semi-finished product complies with the requirements the distribution facility 145 passes the semi-finished product to the transport facility 180 for further handling as a color display unit. The semi-finished product may for example be transported to a package unit 160. Transport and further handling correspond to step S7 of the method described with reference to FIG. 4.

FIG. 6C shows an alternative embodiment of a manufacturing apparatus. Parts thereof corresponding to those in FIG. 6A have the same reference number. In the apparatus of FIG. 6C, the color filter layer is manufactured in a separate process by second unit 120. The so obtained color filter is then transported by transport facility 172 to a test facility 126 that separately tests the color filter for missing or incomplete color filter elements. If this test points out that the color filter does not comply with the requirements, it is transported away by transport facility 175. If the test points out that the color filter does comply with the requirements, the color filter is transported by transport facility 176 to a lamination station 130, where it is laminated with the display layer. The laminated product obtained from lamination station 120 is then transported by transport facility 177 to a further test station 140, where it is verified whether the color filter layer and the display layer are mutually correctly aligned, and whether no air bubbles or dust are enclosed between the layers. Dependent on the outcome of the test, the laminated product is then further processed in a way similar to that described with reference to FIG. 6A.

For obtaining a high accuracy of alignment, e.g. more than 10 μm between the display layer and the color filter layer, the method described with reference to FIG. 6A is preferred. Therein preferably the product to be manufactured is processed on a substrate that is laminated on a rigid carrier such as silica or glass. After completion, the product may be released from the carrier. In the case where a high degree of accuracy is not necessary a lamination apparatus as described with reference to FIG. 6C may be used.

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

What is claimed is:

1. A display comprising a display layer for displaying an image having at least a luminosity component and a color filter layer removably attached thereto that comprises a color filter for filtering the image according to a predetermined pattern.

2. A method for manufacturing a display, comprising the steps of:
providing a display layer for displaying an image having at least a luminosity component,
providing a color filter layer comprising a color filter for filtering the image according to a predetermined pattern, and
removably attaching the color filter layer to the display layer.

3. The method according to claim 2, wherein the color filter layer is removably attached to the display layer by removably applying an intermediate substrate to the display layer and by applying the color filter layer at a surface of said substrate facing away from the display layer.

4. The method according to claim 2, wherein the color filter layer is removably attached to the display layer by applying the color filter layer at a separate substrate and by subsequently removably laminating the separate substrate at the display layer.

5. The method according to claim 2, further comprising a step of testing the provided display layer, wherein the step of removably attaching the color filter layer is only carried out after the provided display layer has positively passed the step of testing the provided display layer.

6. The method according to claim 2, further comprising a step of testing the display after the step of removably attaching the color filter layer, and a step of removing the color filter layer from the display layer if the display does not positively pass the testing of the display after the step of removably attaching the color filter layer.

7. The method according to claim 6, wherein the color filter layer is removably attached to the display layer by an intermediate weak adhesion layer, and the step of removing the color filter layer from the display layer, if the display does not positively pass the testing of the display after the step of removably attaching the color filter layer, is carried out by peeling off the color filter layer from the display layer.

8. The method according to claim 6, wherein the color filter layer comprises a release layer at a surface attached to the display layer, and the step of removing the color filter layer from the display layer if the display does not positively pass the testing of the display after the step of removably attaching the color filter layer is carried out by peeling the release layer with the color filter layer from the display layer.

9. The method according to claim 6, wherein the color filter layer is attached to the display layer by means of an intermediate layer that is soluble in a solvent that does not dissolve the display layer, and the step of removing the color filter layer from the display layer if the display does not positively pass the testing of the display after the step of removably attaching the color filter layer is carried out by selectively dissolving the intermediate layer in a solvent.

10. An apparatus for manufacturing a display comprising:
a first unit for providing a display layer, said display layer being arranged for displaying an image having at least a luminosity component, and
a second unit for providing a color filter layer for filtering the image according to a predetermined pattern, the color filter layer being removably attached to the display layer.

11. The apparatus according to claim 10, wherein the second unit is arranged to removably attach an intermediate substrate to the display layer and to apply the color filter layer at a surface of said intermediate substrate facing away from the display layer.

12. The apparatus according to claim 11, wherein the second unit is arranged to apply the color filter layer at a separate substrate to be laminated with the display layer.

13. The apparatus according to claim 10, further comprising:
a third unit for testing a quality of the product obtained by removably attaching the color filter layer to the display layer, and for providing a failure signal if the quality of the product is not acceptable, and
a fourth unit for removing the color filter layer from the display layer upon activation of the failure signal.

14. The apparatus according to claim 13, further comprising a transport facility for transporting the display layer of which the color filter layer was removed from the fourth unit to the second unit.
